(19) United States
(12) Patent Application Publication
(10) Pub. No.: US 2025/0270029 A1
(43) Pub. Date: Aug. 28, 2025

(54) BEVERAGE POD HAVING A PRESSURIZED DAIRY PRODUCT CANISTER FOR USE IN A BREWING MACHINE

(71) Applicants: Nickolas CHRISTENSEN, San Jose, CA (US); James HAO, San Jose (CA)

(72) Inventors: Nickolas CHRISTENSEN, San Jose, CA (US); James HAO, San Jose (CA)

(21) Appl. No.: 18/590,790

(22) Filed: Feb. 28, 2024

(51) Int. Cl. B65D 85/804

(52) U.S. Cl. CPC B65D 85/8067; B65D 85/8055; B65D 85/8061

(57) ABSTRACT

The present invention pertains to a beverage pod for use in a brewing machine. The beverage pod has a pressurized dairy product canister housed within it. It also contains ground coffee. During the brewing process, hot water is injected into the beverage pod to brew the coffee. At the same time, the canister is triggered to release the pressurized dairy product, thereby creating whipping cream. The coffee and whipping cream flow out of the beverage pod and brewing machine, thereby dispensing a convenient, affordable, delicious cup of cappuccino, latte, or mocha.

### BACKGROUND OF THE INVENTION

### Field of the Invention

Embodiments of the present invention generally relate to a beverage pod that has a pressurized dairy product canister for use in a brewing machine.

### Background of the Present Invention

Coffee is one of the most popular beverages globally, and the market is expanding well into the future. Coffee is delicious, both in taste and smell. It comes in numerous varieties, such as expresso, cappuccino, latte, thereby allowing individuals to tailor their coffee experiences to their preferences. In addition, there are numerous coffee bean varieties, roasting techniques, and brewing methods, offering a wide range of flavors and aromas to explore. Coffee also contains caffeine, a stimulant that can increase alertness and reduce fatigue, making it a go-to choice for professionals, students, and others to kickstart their day or boost their energy levels. There may even be health benefits to drinking coffee.

In order to make coffee more convenient and available, there has been a proliferation of simple, inexpensive coffee brewing machines that use disposable, single-serve coffee pods. A single serve coffee pod, commonly known as a coffee pod, capsule, or cartridge, is a pre-packaged portion of ground coffee beans enclosed in a filter housed within a plastic cup with a sealed, aluminum lid. In other embodiments, the lid can be formed from plastic or some other material. These pods are designed for single use and are compatible with specific coffee brewing systems, such as pod coffee and espresso makers Keurig™ and Nespresso™. Users simply insert a self-contained coffee pod into the coffee machine filled with water, press a button, and coffee is automatically dispensed into an awaiting cup. Thereby, consumers can enjoy a fresh, hot cup of coffee anytime at home, work, or travel.

One problem with these traditional coffee pods is that they are limited to only brewing standard coffee. They cannot make any specialty coffee drinks, such as lattes, cappuccinos, flat whites, cortados, latte macchiatos, espresso macchiatos, mochas, etc. These delicious specialty milk based coffee drinks cannot be made by the traditional coffee pods.

In order to make these specialty milk based coffee drinks, milk is frothed to give the coffee an improved texture, taste, and mouthfeel. There are many ways to froth the milk, such as shaking the milk in a jar, whisking by hand, using an electric mixer, frothing wand, blender, immersion blender, pump frother, etc. However, these methods entail extra work and additional equipment. Consumers typically go to specialty coffee bars to order these specialty coffee drinks. However, there's typically a wait in line to place the order, plus the coffee specialty drinks are very expensive. Hence, it is inconvenient and cost prohibitive to make or buy a specialty coffee drink.

### SUMMARY OF THE INVENTION

The present invention pertains to a beverage pod for use in a brewing machine. The beverage pod has a pressurized dairy product canister housed within it. It also contains ground coffee. During the brewing process, hot water is injected into the beverage pod to brew the coffee. At the same time, the canister is triggered to release the pressurized dairy product, thereby creating whipping cream. The coffee and whipping cream flow out of the beverage pod and brewing machine, thereby dispensing a convenient, affordable, delicious cup of cappuccino, latte, or mocha.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 shows one embodiment of the multiple compartment beverage pod of present invention.

FIG. 2 shows an embodiment of the multiple compartment beverage pod with an outer shell that has openings in its sides.

FIG. 3 shows an embodiment of a beverage (e.g., coffee or tea) brewing machine that accepts a beverage pod which has multiple compartments.

FIG. 4 shows one embodiment of the inside view of a beverage pod with a pressurized canister that has been inserted into a standard beverage dispensing machine.

FIG. 5 shows an embodiment of an aerosol can that is adapted to fit inside a standard beverage pod.

FIG. 6 shows an embodiment of a plate mechanism that rises to actuate an aerosol can.

FIG. 7 shows an embodiment having a trigger system for activating the aerosol can integrated with a beverage pod.

### DETAILED DESCRIPTION

The present invention relates to a single serve beverage pod, capsule, cartridge, or container (hereinafter referred to collectively as a “pod”) that has multiple, separate compartments for containing different ingredients for making the beverage. The self-contained, imperforate beverage pod is hermetically sealed to contain multiple beverage ingredients, which can be either solid or liquid in form, stored in separate, non-permeable compartments. The ingredients are physically separated and kept apart by the multiple, separate compartments or chambers within the beverage pod. The beverage pod is designed to be pierced one or more times to allow liquid (e.g., hot water) to be injected into one or more of the compartments and for ingredients to be ejected from and flow out of the beverage pod into an awaiting cup.

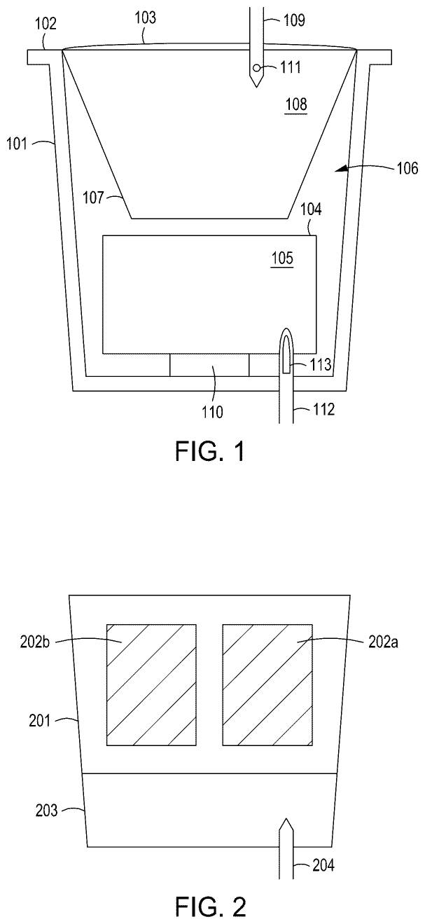

FIG. 1 shows one embodiment of the multiple compartment beverage pod of present invention. A perspective view of a beverage pod 101 is shown. The beverage pod 101 is comprised of a non-permeable (to water and air) outer shell 102 and a top cover 103, which seals the contents housed within the beverage pod 101. Residing within the outer shell 102 and top cover 103 is a solid, self-contained, non-porous, imperforated inner housing 104. Inner housing 104 can be plastic or some other rigid material that can be water tight and/or air tight. The contents contained within inner housing 104 will not leak out or evaporate out of the compartment. Inner housing 104 is set firmly on top of an offset base 110, such that it is raised above the floor of the plastic outer shell 102. This creates a circular gap between the floor of the plastic outer shell 102 and the bottom of the inner housing 104. It should be noted that in other embodiments, there is no gap between the inner housing 104 and the bottom or side of the outer shell 102. In other words, the bottom or side(s) of the outer shell can form part of the inner compartment. The inside of inner housing 104 forms a first compartment 105. This first compartment 105 can be filled with a liquid or solid beverage ingredient. For example, the first compartment 105 of inner housing 104 can be filled with alcohol, liquor, cocktail, mixed drink, garnishes, cocoa, flavorings, sweeteners, honey, cream, seasoning, etc. or a combination thereof. The volume of area outside of inner housing 104 but inside of the plastic outer shell 102 and top cover 103 forms a second compartment 106. A permeable filter 107 defines a third compartment 108, which can holds dry ingredients such as ground coffee, espresso coffee, tea leaves, powdered drink, etc.

In this embodiment, the beverage pod 101 is pierced by one or more needles. More particularly, when used in a brewing machine, the beverage pod 101 is pierced at its top, puncturing and passing through top cover 103, using a hollow needle 109. During brewing, the needle 109 injects liquid (e.g., hot or cold water) into the beverage pod 101 through an opening 111 in the needle 109. The liquid passes through and mixes with the ingredient 108 held by the permeable filter 107. The mixture then flows through compartment 106 and exits through another hollow needle 112. Hollow needle 112 pierces through the bottom of the plastic outer shell 102 and also through container 104. Hollow needle 112 has an opening 113 that extends through both compartment 105 and compartment 106. Thereby, the ingredients in compartments 105 and 106 flow or pass through the hollow needle 112 and exits one or more exit ports in a brewing chamber of the brewing machine (the brewing chamber is the portion of the brewing machine that receives the beverage pod 101) and drips into a pot, cup, or other receiving receptacle. This needle may be referred to as a nozzle.

An example of how this novel beverage pod 101 works is now described in detail. Ground coffee or espresso coffee is held in a filter 107. An alcoholic liquid, such as Irish Cream, whiskey, rum, peppermint schnapps, Kahlua, vodka, martini or any combination of liquors is contained in container 104. The user inserts this pre-packaged beverage pod 101 into the receptacle of a brewing machine designed specifically for receiving such beverage pods. Once the receptacle is closed, the top needle 109 pierces the top cover 103 and the bottom needle pierces the bottom of the outer shell 102 as well as the container 105. The user simply hits a button selecting the serving size. Water from the water receptacle filled by the user is immediately heated to the proper temperature to brew the coffee. Once heated, the water flows through the top needle 109 into the ground coffee within filter 107. The filter keeps the ground coffee from leaving the beverage pod. The brewed coffee flows through the filter 107 into compartment 106 and out from the beverage pod 101 through the hollow bottom needle 112 into an awaiting coffee cup. In addition, the alcohol within 105 also flows through the hollow bottom needle 112. One design allows for both the brewed coffee and the alcohol to flow through the bottom hollow needle 112 at the same time, so as to mix together.

In one embodiment, the top cover 103 and the shell 102 body may form an air-tight enclosure. In other words, the beverage pod 101 may be air-tight. In addition, the interior of the beverage pod 101 may be nitrogen flushed when the top cover 103 is applied to expel oxygen from the enclosure to prevent the degradation of the ingredients. In one example, the body portion of the beverage pod 101 has a truncated conical shape (e.g., shaped like a bucket or pail) or cylindrical in shape. The body portion of beverage pod 101 may include a ring portion which contacts the receptacle seating of the brewing machine that holds the beverage pod 101 in place. In other embodiments, there can be multiple top needles and/or multiple bottom needles. There can also be other paths and openings created, by which hot water can enter compartment 108.

FIG. 2 shows an embodiment of a multiple compartment beverage pod with an outer shell 202 that has openings in its sides. The openings are covered by filters or meshes (e.g., filter 202a and 202b). The inside of the outer shell 202 forms a first compartment that can contain dry ingredients, such as coffee, espresso, tea, etc. A second shell 203 can be fabricated by a solid non-permeable material. Inside of second shell 203 is a second compartment, which can contain a dry or liquid ingredient (e.g., alcohol, dairy product, flavorings, spices, sugar, honey, etc.). Hot water can enter the compartment formed by the outer shell 202 through the top via a hollow needle, mesh, or opening in the top. The hot water can also enter into the first compartment through the filter openings 202a and 202b. The mixture of the water and ingredients of the first compartment (e.g., brewed coffee) can flow out from the openings and filters 202a and 202b. Outer shell 203 can be pierced by a hollow needle 204 or an opening can be created by other means to release the contents or ingredients in the second compartment. The mixture of the water, ingredients from the first compartment, and the ingredients from the second compartment all flow into a cup, mug or other drinking container.

In one embodiment, because the pod is defined by a permeable filter, which acts as a housing for the pod, there is no need to puncture the bottom of the pod in order to extract the brewed liquid.

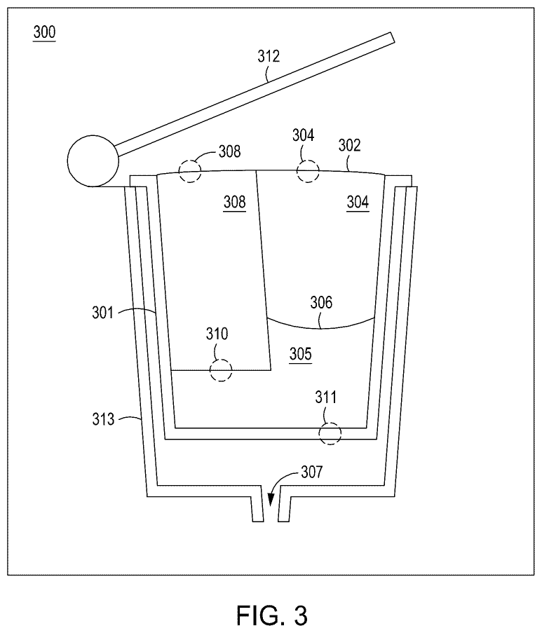

FIG. 3 shows an embodiment of a beverage (e.g., coffee or tea) brewing machine 300 that accepts a beverage pod 301 that has multiple compartments. Beverage pod 301 is a disposable, single-serve or reusable pod for brewing a beverage. It is inserted or laid in place onto a receptacle 313 in the brewing machine. Receptacle 313 is specially designed to accept and fit the beverage pod 301. A lid 312 can be used to open and close beverage pod receptacle 313. Closing lid 312 can activate the brewing process.

Beverage pod 301 is sealed with a top cover 302. Beverage pod 301 has multiple compartments that can contain dry and/or liquid contents therein. One or more of these compartments can be sealed off, isolated, self-contained, water-tight, and/or air-tight. For example, compartment 303 is defined by a solid, non-permeable, imperforated, water-tight plastic container. Consequently, it can contain a liquid (e.g., alcoholic liquor, dairy product, flavor extracts, etc.). In this embodiment, compartment 303 has a vertical orientation. It is more tall than wide. In other embodiments, compartment 303 is horizontal in orientation (e.g., more wide than tall) or a combination horizontal and vertical thereof. A separate compartment 304 can contain a dry ingredient, such as ground coffee, tea leaves, drink powders, etc. A filter, mesh, screen, or membrane 306 can be incorporated to retain the contents of compartment 304. An optional third compartment 305 can contain another type of dry or liquid ingredient (e.g., spices, thickening agent, flavor enhancers, coloring agents, aromatics, etc.). One or more openings can be created in the top, bottom, or sides of these compartments to release their respective contents. For example, compartment 303 can have one or more openings 308 created to vent its contents. Opening(s) 308 can also be created to inject a gas or liquid int compartment 303. One or more openings 310 can be created to release the contents of compartment 303. Similarly, one or more openings 309 can be created to vent or introduce liquids or gases into compartment 304. For example, hot water at the ideal brewing temperature can be pressurized and injected into compartment 304 to brew the coffee contained in compartment 304. Similarly, one or more openings 311 can be created to release the contents of the third compartment 305. For example, the brewed coffee from compartment 304 can flow and mix with cocoa, peppermint, nutmeg, cinnamon, sugar, dairy powder, etc. held by compartment 305. One or more openings 311 in beverage pod 301 can be created to allow the contents of the various compartments 303-305, along with the hot/cold water inserted into the beverage pod to be released and flow into the receptacle 313 holding the beverage pod 301. These openings can be created by needles (hollow or solid), pull-outs, punch-outs, pins, lids, membranes (permeable, dissolvable, elastic), etc. One or more exit ports 307 enables the contents to flow out of the brewing machine 300 into an awaiting cup or beverage holder for the user to drink.

In other embodiments, additional compartments can be implemented in the beverage pod. A third, fourth, fifth, etc. compartment can be used to contain and keep separate any number of liquid or dry ingredients or combination thereof. These additional compartments can be porous or non-porous, rigid or flexible, water tight, and/or air tight.

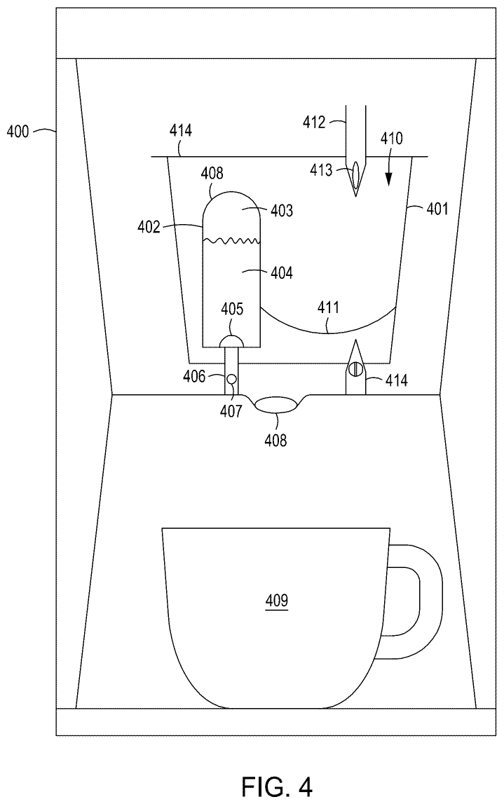

FIG. 4 shows one embodiment of the inside view of a beverage pod 401 that has been inserted into a standard beverage dispensing machine 400. Beverage pod 401 has a canister 402 integrated inside of it. Canister 402 is a pressurized container that contains a propellant gas 403, such as nitrous oxide (N2O), and a milk based product 404 with 10% to over 50% milkfat content (e.g., light cream, half-and-half, whipping cream, double cream, crème fraiche, heavy cream, manufacturer's cream, half cream, coffee cream, full cream, clotted cream, extra thick double cream, sterilized cream, etc.). Canister 402 can also include soy milk, olive oil, coconut cream, almond milk, walnut milk, evaporated milk, dairy free milk, skim milk, sodium caseinate, cashew cream or milk, oat milk, rice milk, milk derivatives, or any other substitute milk or non-dairy, vegan milk alternatives. Canister 402 forms part of an aerosol can that includes a valve 405 and a stem 406. When the beverage pod 401 is depressed, the stem 406 opens the valve 405. The gas propellant 403 forcibly expels the milk product 404 from the canister 402 through an opening 407. Basically, canister 402, valve 405 and stem 406 forms an aerosol can 408. Valve 405 can be implemented as described in U.S. Pat. No. 2,704,172, entitled, “Dispensing Valves for Gas Pressure Containers” which is incorporated by reference in its entirety herein. As the propellant gas is released from canister 402, it expands and causes the released milk product to become frothy. The extruded milk product aerated by the expansion of the dissolved propellant gas forms a firm colloid whipping cream. The whipping cream exits from the beverage pod 401 and drops down the opening 408 in the beverage pod receptacle of the beverage machine 400 into an awaiting cup 409. In one embodiment, opening 408 is external to the beverage pod 401. In other embodiments, the whipping cream is expelled from the canister 402 into the beverage pod 401 and then through an opening or piercing in the beverage pod to the pod receptacle of the beverage machine and finally into the cup 409.

The other compartment 410 that is internal to the beverage pod 401 but external to canister 402 can be used to hold a dry ingredient, such as ground coffee or tea. A filter 411 can filter the dry ingredient, so that the coffee grounds or tea leaves, stay within the beverage pod 401. A hollow needle 412 is used to puncture the top cover 414 of beverage pod 401. Top cover 414 is greater in diameter than the largest diameter of the cylindrical housing of the beverage pod 401. This allows the beverage pod to be set and firmly held down into the pod receptacle of the beverage machine. Hot water is injected through an opening 413 in hollow needle 412 to brew the ingredients held in compartment 410. The brewed beverage then exits the beverage pod 401 through a hollow needle 414 and into cup 409 through the receptacle opening 408. The brewed beverage disperses with the whipping cream in cup 409 for a superior taste and texture drinking experience.

In one embodiment, a solid, non-porous compartment, such as compartment 104 of FIG. 1, compartment 204 of FIG. 2, or compartment 303 of FIG. 3 can be implemented to perform the same function as the canister 402 of FIG. 4. The solid, non-porous compartment is made of a material (e.g., metal, plastic, etc.) strong enough that it can safely contain the nitrous oxide gas and milk cream. A thinner portion of the compartment can be implemented to help pierce the container to release the N2O gas and milk cream. Optionally, a nozzle can be attached to or fabricated with the solid, non-porous compartment in order to facilitate the formation of the whipping cream, once the compartment is pierced. The nozzle can have one or multiple openings, wherein the tips can be shaped to extrude a particular whipping cream design or formation.

An example of the operation of the beverage pod containing a pressurized dairy product canister is now described in detail. The beverage pod 401 is inserted into the pod receptacle of a beverage brewing machine 401. The lid of the pod receptacle is closed. Closing the lid activates the brewing process. It also causes the pin 406 to actuate the valve 405 of canister 402. This releases the whipping cream from canister 402. The whipping cream extrudes from beverage pod 401 and falls into cup 409. The brewing process entails needle 412 piercing beverage pod 401 and injecting hot water at the optimal brewing temperature to brew the ground coffee in compartment 410. The brewed coffee flows through filter 411 and hollow needle 414 (which pierced the outer body of the beverage pod when the receptacle lid was closed) and out of beverage pod 401 through the receptacle opening 408, down into cup 409. The ultimate combination of the whipping cream and the brewed coffee in cup 409 provides a far superior, richer, silkier, creamier, more luxurious taste, texture, and mouthfeel as compared to simple black coffee.

In one embodiment, the canister 402 can also contain sugar, honey, sucralose, aspartame, stevia, or other natural and/or artificial sweeteners. Canister 402 can also include flavor ingredients, such as cocoa (chocolate), caramel, vanilla, nutmeg, cinnamon, mint, or other flavor ingredients that enhances the taste or smell of coffee. Coloring, preservative, anti-coagulant/clumping, and/or thickening agents can also be contained in canister 402. For example, dextrose, modified corn starch, tricalcium phosphate can be included in canister 402.

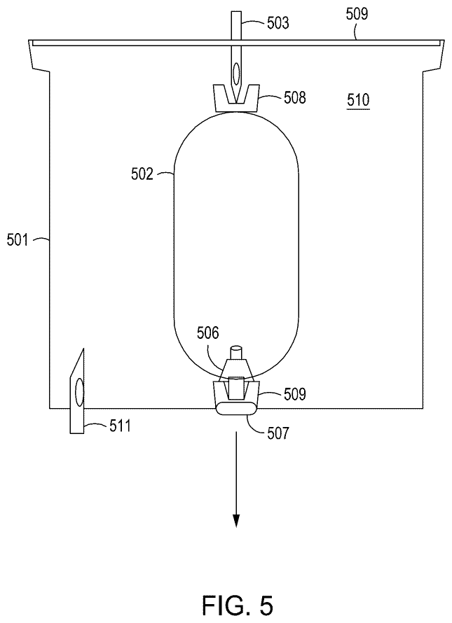

FIG. 5 shows an embodiment of an aerosol can 502 that is adapted to fit inside a standard beverage pod 501. In one example, aerosol can 502 is adapted to fit into a beverage pod 501 that has outside dimensions of 1.5 inches in height, 2 inches in diameter across the top, and 1.5 inches in diameter at the bottom. In order to fit into this particular beverage pod configuration, the aerosol can 502 has a height equal to or less than 1.5 inches and a width equal to or less than 2 inches at its greatest. As shown, aerosol can 502 is cylindrical, but it can be any shape. It can be made of metal, plastic, or any composite material, strong enough to safely hold the pressurized gas and liquid contained therein. A pin, rod, stem, or needle 503 is part of the beverage brewing machine. It is pushed down to pierce the top cover 504 of beverage pod 501. Needle 503 pushes down on the aerosol can 502, which causes a valve 506 to open and allow the gas (e.g., nitrous oxide) and liquid (e.g., milk cream) contents of aerosol can 502 to be released from an opening 507 at the bottom of the beverage pod 501. An optional protective structure 508 is situated on top of aerosol can 502 to afford reinforcement protection to keep aerosol can 502 from being punctured by needle 503 as it is pressed down on aerosol can 502. The protective structure 508 can have a U or V shape to help guide the needle 503. The aerosol can 502 is adapted to be fixedly held in place relative to beverage pod 501. For example, a flange, collar, or other structure or glue, 509 can be used to attach the aerosol can 502 inside of beverage pod 501 at a certain location (e.g., in the approximate middle or center).

An example of the operation of an embodiment of the present invention is now described in detail. The beverage pod 501 is inserted into a receiving receptacle of a brewing machine. When the lid to the receiving receptacle is closed, the lid presses the needle 503 down onto aerosol can 502. This downward force causes the valve 506 to open and dispense its contents (e.g., whipped cream) out from opening 507 and out from the beverage pod 501. Hot water (perhaps pressurized) at the optimal brewing temperature flows out hollow needle 503 and brews the coffee grounds in the area 510 outside of the aerosol can 502, but inside of beverage pod 501. The brewed coffee optionally be filtered before flowing out of beverage pod 501 via the hollow needle 511 that pierces the bottom of beverage pod 501 when the lid of receiving receptacle is closed. The whipping cream and the brewed coffee both flow into the same cup.

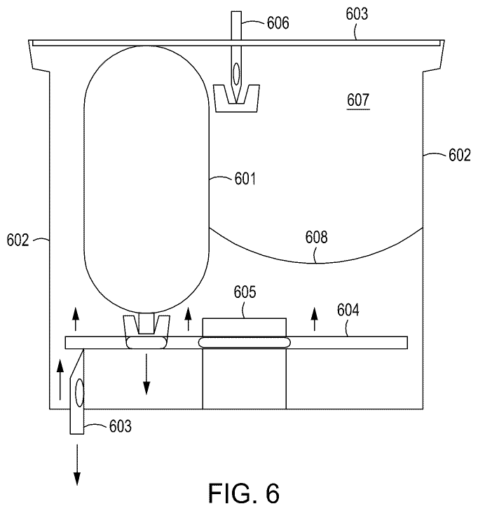

FIG. 6 shows an embodiment of a plate mechanism that rises to actuate an aerosol can. In this particular embodiment, the aerosol can 601 is fixedly placed such that it does not move up and down. This can be accomplished by attaching the side of aerosol can 601 to the inside wall of beverage pod. Alternatively, aerosol can 601 can be placed such that its top is prevented from rising above the cover 603 of beverage pod 602. When the lid of the beverage brewing machine is closed, it causes the beverage pod 602 to be pressed down in the receptacle such that the bottom needle pierces the bottom of beverage pod 602, thereby raising a horizontal plate 604. Horizontal plate 604 rises in a perpendicular motion relative to the bottom of beverage pod 602 by means of a supporting column 605. As the horizontal plate 604 rises, it activates the release of the contents of aerosol can or pod 601. This can be through a spring activated valve or by piercing the aerosol can or pod 601. The contents (e.g., N2O and milk product) of aerosol can or pod 601 is released and flows either around or through horizontal plate 604, down through the hollow needle 603, out from the beverage brewing machine, into a cup. Hot water flows out from the hollow needle 606 into the contents (e.g., ground coffee) of compartment 607. Filter 608 filters the brewed beverage before it flows around horizontal plate 604 and down through hollow needle 603, out of the beverage brewing machine into the same cup. Thereby, hot freshly brewed coffee with whipped cream is conveniently prepared for consumption by the drinker.

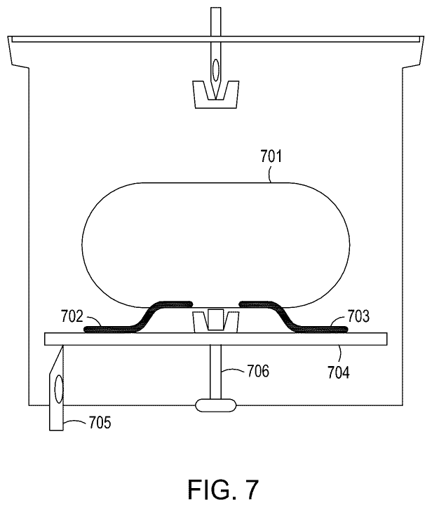

FIG. 7 shows an embodiment having a trigger system for activating the aerosol can integrated with a beverage pod. The aerosol can 701 is activated by one or more triggers 702-703. The triggers 702-703 can be pressed by means of a plate 704. When bottom needle 705 presses upwards on plate 704, one or more triggers 702-703 activates the aerosol can 701, which causes the contents of aerosol can 701 to flow out of hollow stem 706. Alternatively, the contents can flow out of aerosol can 701 through hollow needle 705.

In one embodiment, the aerosol can comprises a container used to store and dispense various substances in the form of a mist or spray. The basic components can include a container, propellant, valve, and actuator. The container is typically made of metal or plastic and holds the substances to be dispensed. The propellant is a compressed gas or a volatile liquid that exerts pressure within the can to expel the contents when the valve is opened. A valve system is the mechanism used to control thee release of the contents from the can. When the valve is depressed, it opens a small aperture through which the pressurized contents are forced out as a spray or mist (e.g., whipping cream). The valve can comprise an orifice insert, actuator, stem, gasket, valve cup, spring, valve housing, and dip tube. The actuator is the part of the valve that is typically pressed to release the contents. It can include a button, nozzle, or spray head.

In one embodiment, the aerosol can is filled with the substance to be dispensed (e.g., heavy cream, water, sugar, corn syrup, nonfat milk, tapioca maltodextrin, mono-and diglycerides, carrageenan, natural flavor, etc.). The propellant (e.g., N2O, compressed air, nitrogen, or carbon dioxide) is added to pressurize the canister. This creates the pressure that forces the substance out when the valve is opened. The pressure keeps the substance in a liquid state within the can. When the vale is depressed by the action of the user (e.g. closing a lid), it opens the valve, allowing the pressurized contents to escape through the aperture in the valve. As the substance passes through the valve, it mixes with the propellant and is expelled from the canister. For example, the expanding N2O gas mixes with the dairy cream and produces whipping cream. The aperture or nozzle is designed to produce the optimal dispensing of whipping cream used in coffee drinks. In addition, the valve is designed to regulate the optimal flow out of the beverage pod such that it does not explode or leak out of the pod in any way other than the intended output opening.

In some embodiments, the single-serve container is a K-cup™ container. K-cup containers are described in greater detail in U.S. Pat. No. 5,840,189, the contents of which are hereby incorporated by reference herein.

In some embodiments, the single serve container may be a T Disc™ style container which is configured for use with a Tassimo™ brewer. T disc style containers are described in U.S. Pat. No. 7,231,869 which was filed on Jan. 23, 2004 and which is incorporated herein by reference.

In some embodiments, the single serve container may be a Nespresso™ container or Nespresso™ compatible container. In some embodiments, the single serve container may be a Nescafe™ Dolce Gusto™ style container.

The containers may take other forms apart from those listed above but the general mode of action is similar. The single serve pod serves to hold and protect the liquid and/or other ingredients internally, where the hot water is introduced to extract the actives and then ejected through the brewing machine head. The beverage pod can be made entirely from compostable and/or recyclable materials. In other embodiments, the beverage pod can be reused many times. A user can refill the compartment(s) and reuse the same beverage pods many times over to brew multiple cups of beverages. They can fill the compartments with various ingredients of their choice to brew drinks that suit their particular tastes.

Although illustrative embodiments of the invention have been described in detail herein with reference to the accompanying figures, it is to be understood that the invention is not limited to those precise embodiment. They are not intended to be exhaustive or to limit the invention to the precise forms disclosed. As such, many modifications and variations will be apparent.

What is claimed is:

1. A disposable, single serve beverage pod for use in a brewing machine, the beverage pod having multiple compartments containing a plurality of different contents that are released during a brewing process, comprising:
a first compartment for containing a first content comprising a gas propellant and a liquid ingredient;
a second compartment for containing a second content comprising a brewing ingredient, wherein the first content and the second content are kept separate before the brewing process begins and wherein when the brewing process begins, the first content is released from the first compartment and the second content is released from the second compartment, portions of the first content and portions of the second content flow out of the beverage pod and are mixed with water from the brewing machine to produce a final beverage for human consumption.

2. The beverage pod of claim 1, wherein the first compartment is comprised of a solid, imperforate, nonporous housing.

3. The beverage pod of claim 2, wherein the content contained in the first compartment comprises a dairy product.

4. The beverage pod of claim 3, wherein the first compartment is water tight and the first content contained in the first compartment comprise a dairy product.

5. The beverage pod of claim 4, wherein the gas propellant in the first compartment comprises a nitrous oxide gas.

6. The beverage pod of claim 1, wherein the second compartment includes a filter.

7. The beverage pod of claim 6, wherein the brewing ingredient in the second compartment comprises coffee.

8. The beverage pod of claim 1, wherein the first compartment comprises an aerosol can.

9. The beverage pod of claim 8, wherein the aerosol can dispenses a whipping cream from the beverage pod when activated.

10. The beverage pod of claim 8 further comprising a trigger mechanism for activating the aerosol can to dispense the first contents from the beverage pod.

11. The beverage pod of claim 1 further comprising a third compartment for containing a third content.

12. A pod for use in a drink dispensing machine, comprising:
an outer shell;
a top cover over the outer shell, wherein the outer shell and top cover forms a first container that stores a first beverage content;
a second container internal to and integrated within the first container for storing a compressed gas and a liquid, wherein during a brewing process, the first beverage content is brewed and the compressed gas and liquid are released from the second container.

13. The pod of claim 12, wherein the second container is comprised of an aerosol can.

14. The pod of claim 12, wherein the liquid comprises a milk cream.

15. The pod of claim 12, wherein the compressed gas comprises nitrous oxide.

16. The pod of claim 12, wherein during a brewing process, the drink dispensing machine injects hot water into the first container to brew coffee and the second container is activated to produce whipped cream, the coffee and whipped cream flow out from the pod and brewing machine.

17. The pod of claim 12, wherein the second container comprises an aerosol container.

18. The pod of claim 17, wherein the aerosol container comprises a valve that is activated to release its contents.

19. The pod of claim 18, further comprising a trigger mechanism for activating the aerosol container.

20. The pod of claim 12, wherein closing a lid on the drink dispensing machine causes a needle to press upwards on a trigger mechanism, which activates the second container to release the compressed gas and liquid.

21. A beverage pod, comprising:
a self-contained first compartment integrated with the beverage pod, wherein the self-contained first compartment can hold a compressed gas and a first beverage ingredient;
a self-contained second compartment integrated with the beverage pod, wherein the self-contained second compartment can hold a second beverage ingredient, wherein the first beverage ingredient and the second beverage ingredient can be mixed with a liquid which forms a beverage dispensed from the beverage pod.

22. The beverage pod of claim 21, wherein the first compartment and the second compartment both reside inside the beverage pod and are external to each other.

23. The beverage pod of claim 22, wherein the first beverage ingredient comprises a liquid and the first compartment holds the liquid without leakage until the liquid is intended to be dispensed from the first compartment.

24. The beverage pod of claim 23, wherein the first beverage ingredient comprises a milk product, the second ingredient comprises ground coffee and wherein the compressed gas is released from the first compartment with the milk product and is combined with a coffee drink brewed from the ground coffee held in the second compartment, the beverage pod dispensing the coffee and the milk product for human consumption.

25. The beverage pod of claim 21, wherein the first compartment comprises a pressurized canister.

26. The beverage pod of claim 25, further comprising a trigger to activate the pressurized canister to dispense the compressed gas and first beverage ingredient.

27. The beverage pod of claim 21, wherein the first compartment is fixedly attached to an approximate center of the beverage pod.
